(19) United States
(12) Patent Application Publication
(10) Pub. No.: US 2017/0043567 A1
(43) Pub. Date: Feb. 16, 2017

(54) WATER VAPOR PERMEABLE, WATERPROOF TEXTILE LAMINATE AND METHOD FOR THE PRODUCTION THEREOF

(71) Applicant: Leister Technologies AG, Kagiswil (CH)

(72) Inventors: Ulrich GUBLER, Buonas (CH); Simon OTT, Luzern (CH); Markus WEDER, Flawil (CH); Frederike LEHMEIER, Kerns (CH)

(21) Appl. No.: 15/286,612

(22) Filed: Oct. 6, 2016

Related U.S. Application Data
(62) Division of application No. 14/297,821, filed on Jun. 6, 2014.

(30) Foreign Application Priority Data
Jun. 7, 2013 (EP) 13 171 000.6

(51) Int. Cl. B32B 37/10; B32B 37/00; B32B 37/06

(52) U.S. Cl. CPC B32B 37/10; B32B 37/065; B32B 37/0053; B32B 2305/18; B32B 2307/724; B32B 2310/0843; B32B 2437/00; B32B 2307/73

(57) ABSTRACT

A water vapor permeable, waterproof textile laminate, comprising at least two layers made of planar web material, which are disposed on top of each other and bonded to each other, wherein an open fabric web comprising polymer fiber threads forms a top tier and a film-like, water vapor permeable, waterproof thermoplastic membrane web forms a bottom tier. The polymer fiber threads of the fabric web comprise raised thread regions, which are held bearing against the membrane web and/or are partially fused into the membrane web, wherein the membrane web comprises integral fusion areas with the raised thread regions, which are generated according to the invention by way of laser light in a laser transmission welding method.

### CROSS-REFERENCE TO RELATED APPLICATION

The present application is a divisional of U.S. patent application Ser. No. 14/297,821 filed on Jun. 6, 2014 and claims priority under 35 USC §119 to European Patent Application No. 13 171 000.6, filed Jun. 7, 2013, the entire disclosures of which are incorporated herein by reference.

### TECHNICAL FIELD OF THE INVENTION

The invention relates to a water vapor permeable, waterproof textile laminate, comprising at least two layers made of planar web material that are disposed on top of each other and bonded to each other, wherein an open fabric web comprising polymer fiber threads forms a top tier, and a film-like, water vapor permeable, waterproof thermoplastic membrane web forms a bottom tier, and wherein the polymer fiber threads of the fabric web comprise raised thread regions, which are held bearing against the membrane web and/or are partially fused with the membrane web. The invention further relates to a method for producing such a textile laminate.

### DESCRIPTION OF THE RELATED ART

Protective clothing as protection against rain and other influences of moisture are intended to keep the wearer of the protective clothing dry by preventing water from penetrating into the clothing from the outside, and by allowing sweat generated by perspiration for regulating body temperature to diffuse through the clothing from the inside to the outside. Comfortable weather-proof clothing must therefore be waterproof and breathable (water vapor permeable). However, it is not necessary for air to penetrate the clothing; it need only be possible to transport the water vapor, originating from the development of sweat, from the inside to the outside (based on the water vapor partial pressure difference from inside to outside), so as to prevent the clothing underneath from becoming moist.

For this purpose, it is now known and customary to produce the clothing from moisture-proof, but water vapor permeable textile composite material, which is to say a textile laminate, which comprises at least two layers that are disposed on top of each other and bonded to each other, comprising a textile fabric web and a film-like, water vapor permeable, thin thermoplastic membrane web, wherein the fabric web forms the top tier and the membrane web forms the bottom tier. The water vapor permeability can be achieved by way of micropores in the membrane or by way of hydrophilic microregions, through which water can diffuse, in the otherwise hydrophobic film. The latter are also referred to as closed-cell or pore-free and are also air-proof, since no apertures proper exist in the membrane. Such protective clothing generally also includes an integrated lining as a third layer to protect the membrane.

Materials for the bottom tier made of breathable waterproof textile laminates are sold worldwide under several known trademarks. These are very thin thermoplastic membrane films, which have only very low mechanical load tolerance, and consequently cannot be processed without additional stabilization as interlining between the textile top tier and the textile lining in clothing items. These extremely flexible membrane films must be laminated onto a thicker soft textile material, or onto the textile top tier, or onto the textile lining, which is to say must be bonded to these by way of bonding spots or bonding lines, which form a regular or irregular pattern.

It is known from the prior art to laminate breathable membranes onto textile fabrics using adhesive spots. The membrane web is frequently bonded to the fabric web by applying mutually spaced hot-melt adhesive spots onto the fabric web, and by subsequently pressing together the fabric web and the membrane web, which have been placed on top of each other, while simultaneously supplying heat to activate the hot-melt adhesive. In areas where the adhesive spots are located, the breathability of the membrane is then substantially blocked, and the Ret value of the membrane increases considerably. So as to mitigate this drawback, DE 38 36 434 A1 discloses a method for producing a textile laminate of the type in question, in which low-viscosity hot-melt adhesive is sprayed in the form of very fine droplets onto one of the sides to be bonded of the fabric web used as the textile web material, or the film-like membrane web. The membrane is thus bonded to the fabric substantially across the entire surface. While smaller hot-melt adhesive spots are achieved in this way, the active adhesive surface is not significantly reduced.

So as to provide a greater breathable surface after the membrane web has been bonded with the fabric web, a method is known from EP 0 163 269 A2 for laminating a thermoplastic breathable film onto a woven fabric to generate a flat coating on the woven fabric, wherein the woven fabric fibers are coated with a material that is absorbent in an infrared wavelength range. After the two layers have been disposed on top of each other, the membrane film and the coated woven fiber fabric are exposed to infrared radiation from a radiation source until the infrared radiation-absorbing layer of the woven fiber fabric heats the film to the softening temperature. The film only softens in areas where it is in contact with the coated fibers, and not in areas of the film covering interstices of the woven fiber fabric. So as to bond the webs to each other, the membrane film and the woven fiber fabric are pressed against each other using vacuum or pressure action until the film-woven fabric composite has cooled, while maintaining the contact. The raised fiber regions are thus partially melted into the membrane film. In this case as well, bonding of the membrane web with the fabric web across substantially the entire surface is achieved, whereby the active surface is similarly limited as with the spray method known from DE 38 36 434 A1.

Moreover, published prior art documents DE 102 11 782 A1, DE 38 06 761 A1 and WO 96/19313 disclose special methods for laser transmission welding and/or for objects produced by way of this proposed method.

DE 102 11 782 A1 discloses a method for attaching a filter material to a holder device. The filter material is first placed onto the holder device. Thereafter, the filter material is fixed by way of a hold-down device. A laser beam is then directed through the hold-down device and the filter material, and the holder device is melted in the joining zone. The melt thereby penetrates the filter material, and as the configuration cools, the filter material becomes united with the holder device.

DE 38 06 761 A1 teaches a deoxidizer parcel having a sack-type parcel body and a deoxidizer contained in the parcel body. At least a portion of the parcel body is made of a composite sheet, which is composed of a gas-permeable layer, such as one made of paper or non-woven fabric, and a plastic film laminated onto the gas-permeable layer and bonded thereto. The plastic film has a plurality of fine pores formed by subjecting the plastic film, which has already been bonded to the gas-permeable layer, to irradiation using a laser beam.

WO 96/19313 discloses a method for forming apertures in the form of holes and/or slots or slits in a web that is intended to form part of an absorbent article, wherein the web is irradiated with at least one focused electromagnetic beam, or a particle beam, from an irradiating source on at least one of the surfaces thereof and in the web regions in which the apertures are to be created. The properties of the beam and the duration of the irradiation period are selected so that the material in these regions receives sufficient energy to melt and/or to vaporize and/or to pyrolyze and/or to burn the material, wherein the resulting molten and/or vaporized and/or pyrolyzed and/or burned material is substantially removed.

Proceeding from the above-described prior art, it is the object of the invention to provide an option that results in increased active surface of the membrane web after it has been bonded to the fabric web.

### SUMMARY OF THE INVENTION

This object is achieved according to the invention by a water vapor permeable, waterproof textile laminate and by a method for producing such a water vapor permeable textile laminate as claimed herein. Further advantageous embodiments can be found in the respective claims dependent thereon.

The membrane web of the textile laminate according to the invention thus comprises fusion areas for the raised fiber regions of the polymer fiber threads of the fabric web, which are created by way of laser light using the laser transmission welding method, wherein the membrane web has a thickness between 4 and 100 μm.

The laser transmission welding method is known per se. It is typically used to bond plastifiable plastic parts by way of welding. The method is particularly suitable for pressure-resistant and flexurally rigid parts, such as plate-shaped or tubular, parts, which are disposed so as to overlap and be in direct contact with each other. In this method, the parts extending across each other are typically pressed against each other and welded together in a weld region by way of a laser beam. It is thus also possible to reliably and sealingly weld together flexible web-shaped plastic materials, starting at a particular thickness. Surprisingly, it was found that the laser transmission welding method can also be employed for bonding flexible film-like plastic material to textile material comprising polymer fiber threads. However, this requires a special kind of pressing technique and a skilled selection of the welding parameters. It is thus also possible to laminate extremely thin membrane webs, such as water vapor permeable membrane webs, such as those used as breathably designed membranes for breathable waterproof clothing, to fabric webs. This is a particularly gentle method, in which fiber regions of the fabric web are integrally fused in a localized manner with the thin and sensitive thermoplastic membrane web under the action of laser light and by applying pressure, which is to say they are welded together. The method can be applied without limitation to all types of textile fabrics comprising polymer fiber threads, regardless of the material and manufacturing type. The novel method is particularly suited for welding fabric webs, as specified above, which comprise a polymer that is compatible from a welding perspective, to at least one membrane web. Typically, these are polyester or polyurethane polymers, for example. The thin, extremely flexible and mechanically easily damaged membrane web can additionally be processed when disposed on a backing film for easier handling, provided this film is made of a material that is incompatible with the membrane web from a welding perspective. The backing film, which is transparent to laser light, is located on the side of the membrane web which faces away from the fabric web and can be easily pulled off the membrane web after the membrane web has been laminated to the fabric web by way of laser. Such a textile laminate can be further processed to obtain weather-proof and breathable clothing items, for example.

Welding using ultrasound, or other conventional welding techniques, damages the thin membrane as a result of the mechanical interaction and causes imperfections at which liquid water can penetrate the membrane web starting from the fabric web. This is reliably prevented with the laser transmission welding method.

In general, it is also possible for the textile laminate according to the invention to have a three-layer design. It then comprises an open fabric web comprising polymer fiber threads, a film-like, water vapor permeable, waterproof thermoplastic membrane web, and a further waterproof thermoplastic film web, which can likewise be designed as a membrane. The fabric web is preferably disposed between the membrane web and the film web, wherein the membrane web and the film web are held bearing against the raised thread regions of the polymer fiber threads of the fabric web and/or are partially fused therewith. The fabric web forms a top tier, the water vapor permeable membrane layer forms a bottom tier, and the additional film web forms a cover tier of the textile laminate. Such a textile laminate, in which the film web is likewise a membrane web, can be further processed for cool pad applications, for example. In cool pads thus produced, two breathable membranes are welded onto the top and bottom of a fabric, so that a cooling effect, similarly to that occurring during sweating of the human skin, is achieved by the evaporation of water from the saturated fabric.

According to the invention, the membrane web is bonded only to the raised thread regions of the fabric web, wherein the number, size, shape and positioning of the fusion areas can be arbitrarily selected by appropriately shaping the beam, directing the beam, shadowing the beam or other suitable measures. The bond can be continuous or discontinuous. Continuous in this context shall be understood to mean a planar bond, in which substantially all raised thread regions of the fabric web are partially fused with, which is to say welded to, the membrane web. The fabric web and the membrane web are preferably discontinuously bonded to each other in one embodiment of the invention. This means that the textile laminate according to the invention has a bonding grid, which comprises a plurality of bonding spots that are disposed at a distance from each other and/or which is composed of a number of bonding lines that are disposed at a distance from each other, extend parallel to each other or intersect each other, and/or which is formed by a number of bonding patterns that are arbitrarily shaped and not connected, or that are connected to each other and arbitrarily shaped.

The membrane web can be locally heated and melted directly and/or indirectly via the fabric web using the laser transmission welding method. For this purpose, the laser beam is alternatively focused onto the membrane web and/or the fabric web, wherein the laser light is preferably directed at the flat side of the membrane web which faces away from the fabric web, and wherein the membrane web and/or the fabric web can comprise dyes that absorb laser light.

In a preferred embodiment of the invention, the membrane web has a water vapor resistance Rₑₜ of less than 20 m² Pa/W.

In general, the fabric web of the textile laminate according to the invention can be present in the form of a woven fabric, a knitted fabric, a warp-knitted fabric, an interlaced product, a stitched product, a non-woven fabric or a felt. The invention also includes that the mutually bonded layers are already pre-cut elements that have been cut out of the corresponding fabric webs and/or membrane webs and positioned in alignment on top of each other.

The method according to the invention for producing a breathable, water-proof above-described textile laminate according to the invention comprises the following steps:
joining the fabric web comprising the polymer fiber threads with the water vapor permeable, film-like, waterproof thermoplastic membrane web;
pressing the membrane web against the fabric web;
applying laser light to the membrane web;
continuously and/or discontinuously bonding the membrane web to the fabric web by heating the fabric web and/or the membrane web using the laser transmission welding method, wherein the application of laser light to the membrane web or to the fabric web takes place as a function of whether the fabric web and/or the membrane web comprise dyes that absorb laser light, until the membrane web has become plastified, and pressing raised thread regions of the polymer fiber threads of the fabric web against the membrane web, or pressing the membrane web against raised thread regions of the polymer fiber threads of the fabric web, forming integral fusion areas between the membrane web and the fabric web; and cooling the membrane web and the fabric web while maintaining the contact pressure.

In a preferred embodiment of the invention, the membrane web is preferably pressed against the fabric web between two plates or rotating rollers by way of pressure application, wherein the plate or roller associated with the membrane web is transparent to laser light. The pressing of the membrane web against the fabric web is carried out either between a support plate and a press plate, or between a support roller and a press roller, using mechanical pressure means, wherein the fabric web is seated against the support plate or the support roller, and the membrane web is seated against the press plate or the press roller. As a result of the press plate or the press roller, which is designed to be transparent to the laser light, the laser light is preferably applied to the membrane web and/or the fabric web using the laser transmission welding method.

As an alternative, in another embodiment of the invention, the membrane web is preferably pressed against the fabric web on a stationary plate or a rotating roller by the application of suction, wherein the plate or roller associated with the fabric web comprises a plurality of suction holes for the membrane web. The pressing of the membrane web against the fabric web is carried out on a support plate or a support roller using suction means, which are operatively connected to the suction holes, wherein the fabric web is seated against the support plate or the support roller, and the membrane web is seated against the fabric web. Negative pressure is applied to the membrane web through the fabric web, so that the membrane web is pressed against the fabric web by the atmospheric pressure acting on the flat side facing away from the fabric web, the fabric web being supported against the support plate or the support roller.

Otherwise, the membrane web can advantageously also be pressed against the fabric web by applying a blowing action to the membrane web on a plate or a rotating roller. The membrane web is pressed against the fabric web on a support plate or a support roller, wherein the fabric web is seated against the support plate or the support roller, and the membrane web is seated against the fabric web, by way of blowing means, which are disposed opposite the support plate or the support roller. At least one compressed air jet (cold or preheated) originates from the blowing means, the jet being directed at the membrane web located between the blowing means and the support plate or support roller. As a result of the application of the blowing action using compressed air, the membrane web is pressed in the direction of the support plate, or of the support roller, against the fabric web supported thereon.

In a preferred embodiment of the invention, the membrane web is pressed against the fabric web on a rotating support roller by applying a tensile action to the membrane web. The application of the tensile action is achieved by a tension roller, which is disposed opposite the support roller so that the tension roller tensions the membrane web and also draws it against the contact press roller against which the fabric web is seated. The laser light originating from a laser light source disposed opposite the support roller is aimed directly at the membrane web. This teaching also includes the physical reversal of this configuration, in which the membrane web is seated against the support roller, and the fabric web is drawn against the membrane web by the application of an appropriate tensile action, so that the fabric web and the membrane web are supported against the support roller. In this case, the laser light is directed through the support roller at the membrane web, which must then of course be designed to be transparent to the laser light.

So as to press the membrane web against the fabric web by the application of suction, a compensating plate is preferably disposed on the membrane web opposite the support plate, or a compensating web is merged with the membrane web opposite the support roller, wherein the compensating plate, or the compensating web, is considerably more flexurally rigid than the membrane web and is transparent to the laser light. The compensating plate, or the compensating web, on the membrane web evenly distributes the atmospheric pressure acting on the flat side facing away from the fabric web and prevents the membrane web from becoming deformed in the shape of depressions between the raised thread regions of the polymer fiber threads of the fabric web.

So as to press the membrane web against the fabric web by the application of a blowing action, a compensating plate is preferably likewise disposed on the membrane web opposite the support plate, or a compensating web is merged with the membrane web opposite the support roller, wherein the compensating plate, or the compensating web, is considerably more flexurally rigid than the membrane web and is transparent to the laser light. The compensating plate, or the compensating web, on the membrane web evenly distributes the blowing pressure of the compressed air acting on the flat side facing away from the fabric web and prevents the membrane web from becoming deformed in the shape of depressions between the raised thread regions of the polymer fiber threads of the fabric web.

In general, the invention also includes the physical reversal of the above-described measures, at least with regard to pressing the membrane web against the fabric web by the application of a blowing action. The membrane web can thus also be directly seated on the contact plate, or can be directly supported against the rotating contact roller, wherein then, on the flat side of the fabric web which faces away from the membrane web, in any case a compensating plate must be disposed on the membrane web opposite the support plate, or a compensating web must be merged with the membrane web opposite the support roller, so as to press the open fabric web against the membrane web. Of course, the contact plate, or the contact roller, is then designed to be transparent to laser light so as to be able to apply laser light to the membrane web.

According to the invention, the proposed novel bonding method for the membrane web and the fabric web is preferably used to discontinuously bond the fabric web and the membrane web to each other. For this purpose, the fusion areas are generated during the laser transmission welding method after the membrane web has been pressed against the fabric web, or conversely, by way of a shadow mask, a diffractive optical element or a laser scanner. To this end, a spot or line pattern for bonding the membrane web to the fabric web is projected onto the membrane web and the fabric web, the pattern having extremely fine values. The breathable surface of the membrane web is thus considerably increased, whereby a reliable and permanent bond between the membrane web and the fabric web is ensured.

The invention will be described hereafter in more detail based on several exemplary embodiments that are illustrated in the drawings. Additional features of the invention will be apparent from the following description of the exemplary embodiments of the invention in conjunction with the claims and the accompanying drawings. The individual features can be implemented either alone or as several together in different embodiments of the invention. In the drawings:

### BRIEF DESCRIPTION OF THE DRAWINGS

FIG. 1 shows an enlarged section of a textile laminate according to the invention, comprising a membrane web that is laminated to a fabric web;

FIG. 2 shows a representative illustration of a configuration for carrying out the laser transmission welding according to the invention for bonding a membrane web to a fabric web, forming the textile laminate according to the invention of FIG. 1;

FIG. 3a shows a structuring type for discontinuously bonding the membrane web to the fabric web in a definable grid by way of the method shown in FIG. 2, using a shadow mask;

FIG. 3b shows a structuring type for discontinuously bonding the membrane web to the fabric web in a definable grid by way of the method shown in FIG. 2, using a diffractive optical element;

FIG. 3c shows a structuring type for discontinuously bonding the membrane web to the fabric web in a definable grid by way of the method shown in FIG. 2, using a laser scanner;

FIG. 4a shows the laser transmission welding method according to the invention for bonding the membrane web to the fabric web, in which the membrane web is pressed against the fabric web by applying mechanical pressure to the membrane web in conjunction with a contact plate;

FIG. 4b shows the laser transmission welding method according to the invention for bonding the membrane web to the fabric web, in which the membrane web is pressed against the fabric web by applying suction to the membrane web in conjunction with a contact plate;

FIG. 4c shows the laser transmission welding method according to the invention for bonding the membrane web to the fabric web, in which the membrane web is pressed against the fabric web by applying a blowing action into the membrane web in conjunction with a contact plate;

FIG. 5a shows the laser transmission welding method for bonding the membrane web to the fabric web, in which the membrane web is pressed against the fabric web by applying mechanical pressure to the membrane web in conjunction with a rotating contact roller; and

FIG. 5b shows the laser transmission welding method for bonding the membrane web to the fabric web, in which the membrane web is pressed against the fabric web by applying suction to the membrane web in conjunction with a rotating contact roller; and

FIG. 5c shows the laser transmission welding method for bonding the membrane web to the fabric web, in which the membrane web is pressed against the fabric web by applying a blowing action to the membrane web in conjunction with a rotating contact roller; and

FIG. 6 shows the laser transmission welding method for bonding the membrane web to the fabric web, in which the membrane web is pressed against the fabric web by tensioning the fabric web and the membrane web against a rotating contact roller.

### DETAILED DESCRIPTION OF THE INVENTION

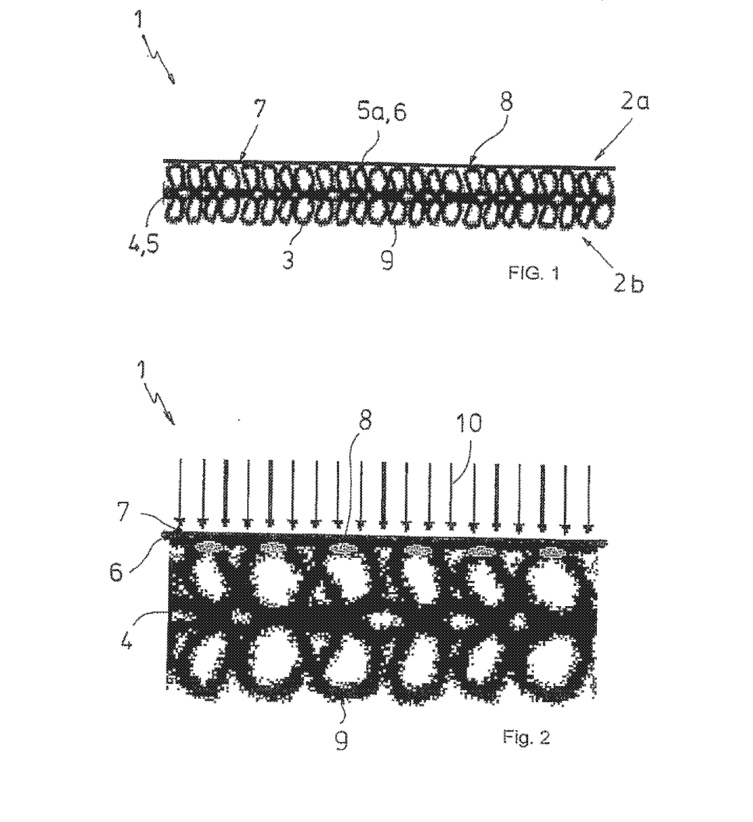

FIG. 1 shows a water vapor permeable, waterproof textile laminate 1, preferably intended for further processing to obtain weather-proof clothing items, comprising two layers 2a, 2b made of planar web material, which are disposed on top of each other and bonded to each other, wherein an open fabric web 4 comprising polymer fiber threads 3 forms a top tier 5 and a film-like, water vapor permeable, waterproof thermoplastic membrane web 6 forms a bottom tier 5a. The polymer fiber threads 3 of the fabric web 4 comprise raised thread regions 7, which are held bearing against the membrane web 6 and/or are partially integrally fused with the membrane web 6. The membrane web 6 comprises fusion areas 8 for the raised thread regions 7 generated during the laser transmission welding method. The fabric web 4 is produced in the manner of a woven fabric, a knitted fabric, a warp-knitted fabric, an interlaced product, a stitched product, a non-woven fabric or a felt. The membrane web 6 bonded to the fabric web 4 has a water vapor resistance Ret of less than 20 m²Pa/W and a thickness between 4 and 100 μm. The fabric web 4 and/or the membrane web 6 are provided with dyes absorbing laser light, which are not shown in the drawing.

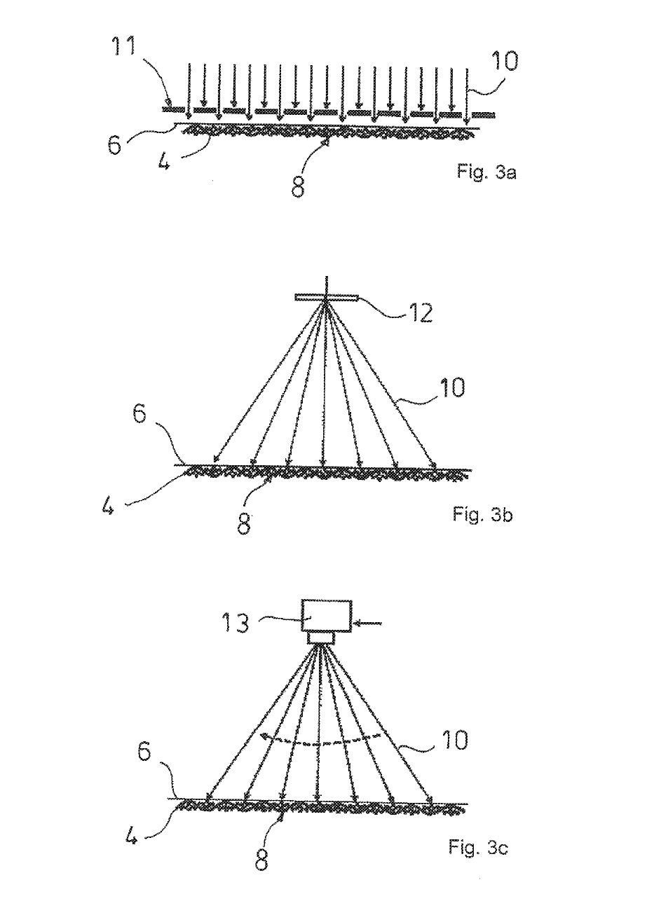

FIG. 2 shows a representative illustration of a configuration for the laser transmission welding method according to the invention for bonding the membrane web 6 to the fabric 4, forming the textile laminate 1 according to the invention. The fabric web 4 is a knitted product, such as a knitted fabric, for example. The fabric web 4 comprises polymer fiber threads 3, which form loops 9. It is disposed in an extended and planar manner and carries the membrane web 6. The membrane web 6 is seated against the raised thread regions 7 of the polymer fiber threads 3 forming the loops 9 which, after local plastification of the membrane web 6 at the fusion areas 8 as a result of the laser transmission welding method, are partially fused locally with the membrane web 6 as the membrane web 6 is pressed against the fabric web 4. Laser light 10 is applied to the membrane web 6 so as to plastify the same. The laser light source from which the laser light originates is not shown in the drawing.

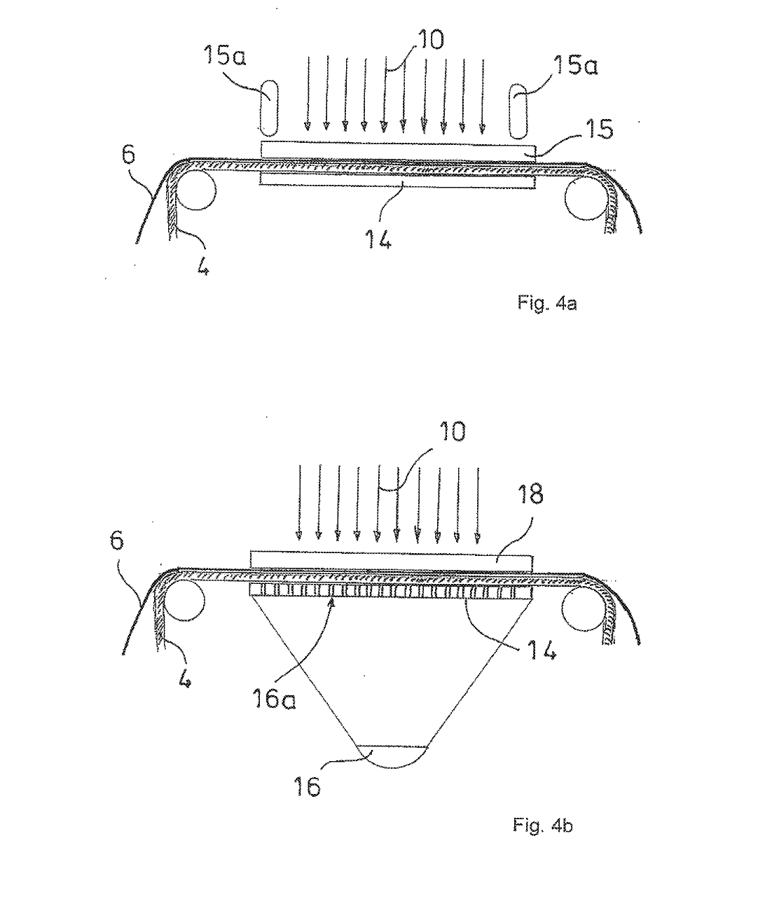

FIG. 3 shows different structuring types for discontinuously bonding the membrane web 6 to the fabric web 4 in a definable grid by way of the laser transmission welding method, which is only representatively illustrated in FIG. 2. According to FIG. 3a, the textile laminate 1 according to the invention is structured by way of a shadow mask 11, which locally shadows the membrane web 6 in a predetermined grid. Fusion areas 8 for the polymer fiber threads 3 with the membrane web 6 are created where the shadow mask 11 allows the laser light 10 to pass through. FIG. 3b illustrates the structuring of the textile laminate 1 according to the invention by way of a diffractive optical element 12 (DOE) which, similarly to the shadow mask 11, generates a simultaneous pattern on the membrane web 6. As a result of the DOE 12, the laser light 10 undergoes local phase shifts, which result in a pattern of fusion areas 8 that is determined by the DOE 12 being projected on the membrane web 6. FIG. 3c shows the corresponding structuring of the textile laminate 1 by way of a laser scanner 13, which generates a corresponding desired pattern in one pass. FIGS. 3a to 3c show the laser 10 only symbolically, the depiction of the laser light source from which the laser light 10 originates being omitted. The function, design, use and mode of operation of shadow masks, diffractive optical elements and laser scanners have already been disclosed in a variety of publications of the prior art with respect to the laser transmission welding method, which is known per se, and are therefore common knowledge to the person skilled in the art, such they need not be described in more detail here.

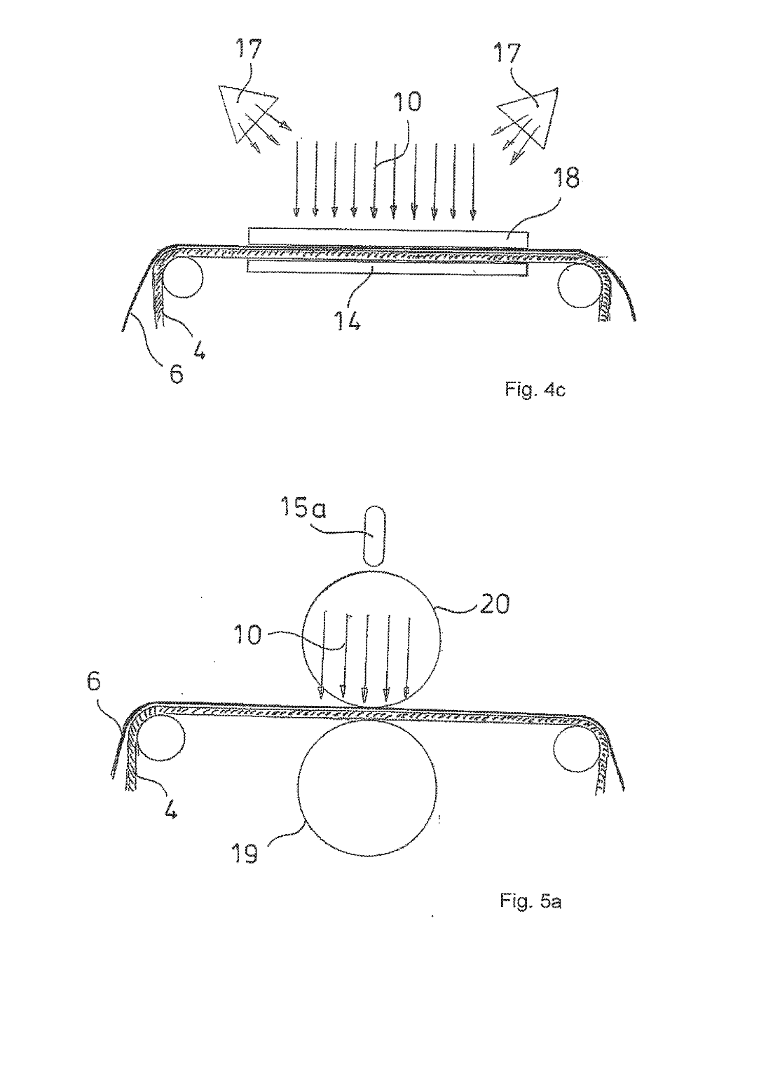

FIG. 4 shows the laser transmission welding method according to the invention for continuously bonding the membrane web 6 to the fabric web 4 in greater detail.

FIGS. 4a, 4b, 4c show three basically different possible variants for pressing the membrane web 6 against the fabric web 4 during the laser transmission welding method. In all three illustrations, the fabric web 4 is seated against a support plate 14. The membrane web 6 is disposed in each case on the fabric web 4 and is pressed against the fabric web 4 by mechanical pressure application in the variant according to FIG. 4a, by the application of suction in the variant according to FIG. 4b, and by the application of a blowing action in the variant according to FIG. 4c.

The application of mechanical pressure is carried out by way of a press plate 15, which is placed on the membrane web 6 and which is configured with pressure means 15a. The press plate 15 is transparent to the laser light 10, so that the laser light 10 can be directed through the press plate 10 at the membrane web 6. The application of suction to the membrane web 6 is carried out by way of suction means 16, which communicate with suction holes 16a, a plurality of which are formed in the support plate 14. The membrane web 6 is drawn in the direction of the support plate 14 via the suction holes 16a and thus is pressed against the fabric web 4. The application of a blowing action to the membrane web 6 is carried out by way of blowing means 17, which are disposed opposite the support plate 14 at a distance from the membrane web 6 and which press the membrane web 6 against the fabric web 4. So as to prevent the membrane web 6 from becoming deformed, an additional compensating plate 18, which is transparent to the laser light 10, is disposed on the membrane web 6. This plate evenly presses the membrane web 6 against the fabric web 4 and the support plate 14.

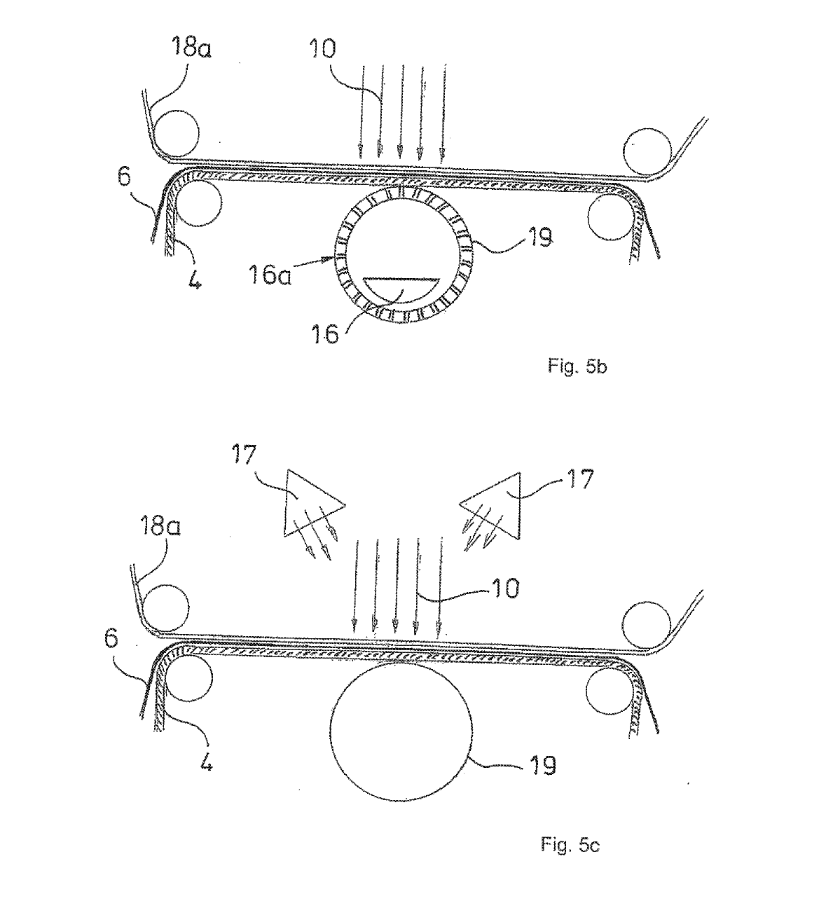

FIG. 5 shows technical modifications of the embodiments shown in FIG. 4 for pressing the membrane web 6 against the fabric web 4. The basic idea remains unchanged but in the embodiment variants shown in FIGS. 5a to 5c, the support plate 14 is generally replaced by a rotating support roller 19. The linear contact on the roller can be increased by using a soft elastic material for the roller surface, or by guiding the fabric web 4 and the membrane web 6 seated thereon not in a planar manner, but rather in a curved manner, over the roller. The curvature of the fabric web 4 and of the membrane web 6 is dependent on the diameter of the contact roller 19. Moreover, the press plate 15 is replaced by a correspondingly designed press roller 20, and the compensating plate 18 is replaced by a compensating web 18a.

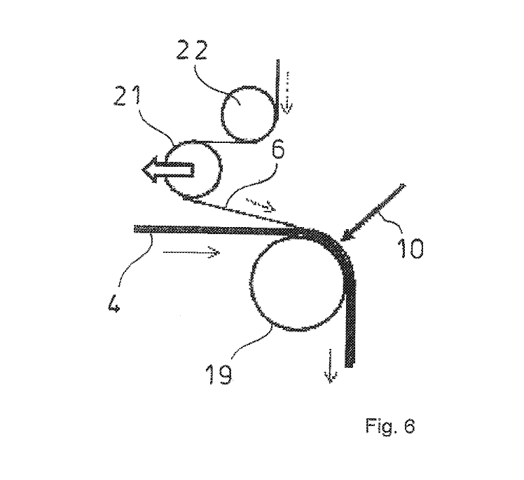

FIG. 6 shows a further option for pressing the membrane web 6 against the fabric web 4 in conjunction with a rotating support roller 19, in which no press roller 20 is required. The fabric web 4 is thus seated against the support roller 19, and the membrane web 6 is seated against the fabric web 4. The fabric web 4, as well as the membrane web 6, are tensioned against the support roller 19. A corresponding tension roller 21 is provided for this purpose which, in conjunction with a specially disposed guide roller 22, draws the membrane web 6 in the direction of the support roller 19. The pretensioned membrane web 6 is supported against the fabric web 4 in the direction of the support roller 19 and presses the fabric web 4 against the support roller 19.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1-4. (canceled)

5. A method for producing a breathable waterproof textile laminate including at least two layers made of planar web material, which are disposed on top of each other and bonded to each other, an open fabric web comprising polymer fiber threads forming a top tier and a film-like, water vapor permeable, waterproof thermoplastic membrane web forming a bottom tier, and the polymer fiber threads of the fabric web comprising raised thread regions, which are held bearing against the membrane web and/or are partially fused with the membrane web, wherein the membrane web has a thickness between 4 and 100 μm and comprises integral fusion areas with the raised thread regions of the fabric web, which form a continuous and/or a discontinuous bond between the fabric web and the membrane web, wherein in the case of the continuous bond, a planar extensive bond is created, in which substantially all the raised thread regions of the fabric web are partially fused with the membrane web, and wherein in the case of the discontinuous bond, a defined bonding grid exists, in which raised thread regions of the fabric web disposed in a spot and/or line pattern are locally partially fused with the membrane web, the method comprising the following steps:
joining the open fabric web comprising polymer fiber threads with the film-like, water vapor permeable, waterproof thermoplastic membrane web;
pressing the membrane web against the fabric web;
applying laser light to the membrane web;
continuously and/or discontinuously bonding the membrane web to the fabric web by heating the fabric web and/or the membrane web using a laser transmission welding method, wherein the application of laser light to the membrane web or to the fabric web depends on whether the fabric web and/or the membrane web comprise dyes absorbing laser light, until the membrane web has become plastified, and pressing the raised thread regions of the polymer fiber threads of the fabric web against the membrane web by pressing the fabric web and the membrane web against each other, forming integral fusion areas between the membrane web and the fabric web; and
cooling the membrane web and the fabric web while maintaining the pressing action.

6. The method according to claim 5, wherein the membrane web is pressed against the fabric web between a support plate and a press plate, or between a rotating support roller and a rotating press roller, by mechanical pressure application, wherein the fabric web is seated against the support plate or the support roller, and the membrane web is seated against the press plate or the press roller, and the press plate or the press roller is designed to be transparent to laser light.

7. The method according to claim 5, wherein the membrane web is pressed against the fabric web on a stationary support plate, or on a rotating support roller by the application of suction, wherein the fabric web is seated against a support plate or a support roller, and the membrane web is seated against the fabric web, and the support plate or the support roller, comprises a plurality of suction holes for the membrane web.

8. The method according to claim 5, wherein the membrane web is pressed against the fabric web on a support plate or on a rotating support roller, by the application of a blowing action to the membrane web, wherein the fabric web is seated against the support roller.

9. The method according to claim 5, wherein the membrane web is pressed against the fabric web on a rotating support roller by the application of a tensile action to the membrane web.

10. The method according to claim 7, wherein a compensating plate is disposed on the membrane web opposite the support plate, or a compensating web is joined with the membrane web opposite the support roller, so as to press the membrane web against the fabric web, wherein the compensating plate, or the compensating web, is more flexurally rigid than the membrane web and is transparent to the laser light.

11. The method according to claim 8, wherein a compensating plate is disposed on the membrane web opposite the support plate, or a compensating web is joined with the membrane web opposite the support roller, so as to press the membrane web against the fabric web, wherein the compensating web is more flexurally rigid than the membrane web and is transparent to the laser light.

12. A method according to claim 6, wherein after the membrane web has been pressed against the fabric web, the positions of the fusion areas in the laser transmission welding method are determined by way of a shadow mask, a diffractive optical element or a laser scanner.
